(19) United States
(12) Patent Application Publication
(10) Pub. No.: US 2006/0085199 A1
(43) Pub. Date: Apr. 20, 2006

(54) System and method for controlling the behavior of a device capable of speech recognition

(76) Inventor: Yogendra Jain, Wellesley, MA (US)

Correspondence Address: Yogendra Jain;Personica Intelligence, Inc., 10 South Woodside Ave, Wellesley, MA, 02482, US

(21) Appl. No.: 11/253,344

(22) Filed: Oct. 19, 2005

Related U.S. Application Data
(60) Provisional application No. 60/619,974, filed on Oct. 19, 2004.

(51) Int. Cl. G10L 21/00

(52) U.S. Cl. 704/275

(57) ABSTRACT

The present invention discloses a system and method for controlling the behavior of a device in response to voice commands or other system events. By utilizing the system of the present invention, a user may select the time period(s), or the system may automatically select the time period based on certain conditions such as day of the week, system event, urgent message, etc., during which the device is more or less responsive to voice commands. Furthermore, when the device is more or less responsive, any external trigger such as an message announcement, alarm, email alert, etc., the device takes into account its current “responsiveness” and behaves differently than when is in a normal mode.

### CROSS-REFERENCE TO RELATED APPLICATIONS

This application claims the benefit of U.S. Provisional Application No. 60/619,974 filed Oct. 19, 2004, which is incorporated by reference in its entirety herein, and form which priority is claimed.

### FIELD OF THE INVENTION

The present invention generally relates to the field of controlling the activation and behavior of a device capable of user interface via multi-modal speech recognition. More particularly, the present invention provides a system and method for controlling the behavior of a device in response to spoken commands or other system events during specific time period(s) and/or situations.

### BACKGROUND OF THE INVENTION

Currently there has been a strong trend to make different consumer electronics more user-friendly by incorporating multi-modal and speech-recognition technology into their operation. For example, many cell phones allow you to dial a telephone number just by speaking the associated person's name. Speech recognition software located within the cell phone decodes the spoken name, matches it to an entry in the user's address book, and then dials the number.

Additionally, many computers can now be controlled through spoken commands by installing additional third-party software. The software allows the user to perform common tasks, such as opening and saving files, telling the computer to hibernate, etc. Some programs even allow the user to dictate directly into a word processing program. Some of the newer devices such as VoIP telephone in the home use PC or some network server in the background to offer not only telephone service but can use voice to control or activate other home appliances, music, entertainment, content, services, etc. Most consumer devices which have incorporated speech-recognition technology perform speech-recognition either in an “always on” mode or only during a predetermined time window. For example, when a user wishes to utilize the voice dialing feature on their cell phone, he/she must say the person's name in the certain time period which is specified by the cell phone. If the user fails to say it during that time period, no number will be dialed.

If a device with voice-recognition capabilities operates in an “always on” mode, it will respond to commands unless the user specifically turns the speech recognition capabilities off. This could potentially lead to situations in which the device reacts to commands at the inappropriate time. For example, if a computer with speech recognition technology heard a “Play Music” command which originated from a television left on during the middle of the night, it could possibly begin playing loud music throughout the house of the user and wake everyone up.

Corollary to “always listening” some speech based devices or applications may play “vocal messages” such as advertisement, spam, and other messages or even when a user gives a command, it may vocal means to respond back to the user. There is a need for these devices to be selective based on users preferences to not only “not listen” but also not become activated from external or internal events during selected period or modes.

Therefore, there clearly exists a need for a system and method for controlling the time periods and situations during which a device capable of speech recognition is responsive to commands and/or attention words/and or messages. The system and method should be highly modifiable to allow it to be adaptable to many different devices and systems.

### SUMMARY OF THE INVENTION

The present invention discloses a system and method-for controlling the behavior of a device in response to voice commands or other system events. By utilizing the system of the present invention, a user may select the time period(s), or the system may automatically select the time period based on certain conditions such as day of the week, system event, urgent message, etc., during which the device is more or less responsive to voice commands. Furthermore, when the device is more or less responsive, any external trigger such as a message announcement, alarm, email alert, etc., the device takes into account its current “responsiveness” and behaves differently than when it is in a normal mode.

In the preferred embodiment, the system of the present invention can be implemented on any one of a plurality of client or base devices which are dispersed throughout a home. For example, a base device may be located in a home office while different client devices may be located in the bedroom, kitchen, television room, etc. All of the client devices are preferably in communication through a wireless or wired network managed by a server or a router. The speech recognition can either be performed locally on each of the client or base devices or it may all be performed at one or more central locations using a distributed processing architecture.

The client or base device on which the system of the present invention operates is preferably composed of a central processing unit, RAM, a speech recognition module, an interface client module, one or more external speakers, one or more microphones, visual display(s), an attention button, and an exclusive Quiet Hours button or another button which can by software be configured to double up as a Quiet Hours activation button. The central processing unit (“CPU”) is responsible for controlling the interaction between the different components of the device. For example, the CPU is responsible for passing voice data from the microphone connected A/D and D/A to the speech recognition module for processing, controlling the information on the visual display, etc. Such processing elements can be embedded in a telephone handset, PC, media station, network computers, music appliances, remote control handset, universal remotes, set-top box, TV, wireless telephones, watch, etc.

The computer “personalities” which interact with users are stored in the interface client database connected to the CPU. During normal operation, the device constantly monitors (listens) for an attention word - a spoken word or sound such as device name or some trigger sound. Each sound and utterance received by the microphone is digitized, appropriately processed by the front end (end pointing, automatic gain control, background noise cancellation) and passed to the CPU, which transmits it to the speech recognition module. As previously discussed, the CPU may reside locally on a client Device or the speech data may be transmitted to another CPU which may be dedicated for Quiet Hours and related tasks. If the speech recognition module recognizes an “attention word,” the device becomes active and responsive to other voice commands. It should be obvious to one skilled in the art that the CPU may also perform the functions of the speech recognition module if it has sufficient processing power.

After detection of an attention word, the device accesses the interface client database and loads the correct interface client into RAM. An interface client is a lifelike personality which can be customized for each user of the device. Different applications installed on the device, such as an application for playing music, may utilizes customized interface clients to interact with the user. For example, an application which plays music might use an interface client which behaves like an upbeat disc jockey.

Once the interface client has been loaded into RAM, it is able to interact with the user through the speaker(s) and microphone(s) attached to the external housing of the device. The interface client may also utilize the visual display to interact with the user. For example, the interface client may appear as a lifelike character on the visual display which appears to speak the words heard through the speaker. In the preferred embodiment, the interface client stays active for a predetermined amount of time, after which the device again begins monitoring for an attention word.

The quiet hours module is a programmable module which allows the user to set the time period(s) during which the device will not respond to an attention word. If a user accidentally speaks an attention word or the system mistakes room noise or other speech for an attention word while the quiet hours module is active, the device will not respond. This feature is useful to prevent the system from waking up at night and disturbing the user or if some users are constantly saying an ‘attention word’ to play with the system, etc.

Quiet Hour Mode Operation:

There are many modes in which the quiet hours module may operate. In the preferred embodiment, a user can program or select the different modes of operation by interacting with the device through spoken commands.

In a first and preferred mode of operation, the quiet hours module disables the speech recognition module while it is active. In this mode, the only way for a user to interact with the interface client is for the user to press the attention word button. After the attention word button has been pressed, the CPU overrides the operation of the quiet hours module and reactivates the speech recognition module for a predetermined period of time. During this time period, the user may interact with the interface client. After the time period has expired, the quiet hours module resumes its pre-programmed operation.

Other Methods of Setting Quiet Hours

In addition to pressing the Quiet Hour button, the quiet hours may be settable in other ways including
1) a user giving verbal command such as “stay quiet for 30 minutes” or “go into Quiet Mode”, etc.;
2) going to the web configuration and setting the quiet mode for the present or for some future time span in as a single or a recurring event;
3) the client device application asking the user if the users would like it go in Quiet mode (for example when the system keeps waking up and there are no commands after that).

In a second mode of operation, the quiet hours module may only be deactivated in response to a pre-programmed event. For example, if the user had programmed the device to activate an alarm during a period when the quiet hours module was scheduled to be active, the CPU would override the operation of the quiet hours module and sound the alarm at the scheduled time. After the system event has taken place, the quiet hours module would then reassume its pre-programmed operation.

Upon setting the quiet mode, the device may give a verbal acknowledgement and/or visual (via LED or graphics message) and/or web application trigger if the device status is visible to the web.

For some client devices, Quiet Hours may not be an option or settable and when pressed, the system will announce to the user that “Quiet hours is disabled . . . ” and that the Quiet Hour indicator would not be turned on. This feature would be helpful if a parent did not wish to activate quiet mode for their kid's room and wanted to constantly monitor any sound activity. Another variation of this mode may be that when the quiet hours mode is active, the device will not respond to and the device will not understand user voice activation. However, the system is still able to respond to a telephone ring, event trigger, using other buttons or screens. There may be some event triggers that are of high or critical level and will require users' attention. Other events such as system maintenance, RSS feeds of non-critical events, a blog update or posting, an incoming ad message, voice mail message which is not marked urgent or the system does not identify as known urgent message, may be ignored and stored for release after the quiet hours mode is exited. To avoid inundating the user with messages, the device may hold off sharing these individual messages and offer user a summary of the different trigger events.

For a device with a dedicated visual display, trigger events, message counts, and type of message, may be displayed. In this mode, during quiet hours, the screen may not brighten depending on the setting and time of day, etc. For devices which don't have a dedicated screen and use screens from other appliances or device functionality (including Quiet Hours) is partially or fully embedded in these appliances such as such as a TV, Home Theater, Game Player, or other Display screen, these screens may not turn on or fully brighten during Quiet Hours to minimize the disturbance. Some of these appliances have their own audio that can be misunderstood for an “attention word” or a “command trigger” or a “conversational trigger.” For these appliances, quiet hours may be activated when the user is using the appliance to some capacity or capability. For example if the TV appliance is playing a show, Quiet Hours may be enabled automatically to avoid false trigger.

Quiet Hours may itself have different threshold levels. For some Devices, it may be on or off, but in other devices where great deal of background noise exists or TV is playing in the background, the strong “attention word” or “command” needs to be heard for the device to responds. Depending on the threshold level, the Quiet Hour LED brightness may vary (far brighter if it is completely shut off or less bright if it requires a strong recognition of “attention word/command.”

In an alternate embodiment of the present invention, the quiet hours module setting may be unique for each interface client. In this embodiment, the quiet hours module settings for the active interface client will be utilized unless a global setting has been set for all interface clients.

The operation of the quiet hours module may also be interrupted when a validated urgent message is detected by the device. In response to the message, the device may notify the user of the message via blinking LEDs or a text display of the message. The Quiet Hours LED or indicator may also blink alerting a user. The device will then deactivate the quiet hours module and listen for an attention word and/or other command spoken by a user.

In some configurations, a user may be able to deactivate the quiet hours module by saying a special word or phrase several times such as “‘personica’ wake up; ‘personica—wake up.” This feature would be especially useful for handicapped people who are unable to access or locate the device (such as a blind person).

Another advantage of the “quiet mode” which occurs when the quiet hours module is active is that the processing burden on the CPU is significantly reduced. During this mode, the CPU can perform self diagnostics, tuning, monitor background noise, play multi-channel music in other rooms on other devices, cache data for the user in anticipation of commonly requested data, download new application(s), and/or conserve power if batteries are being used to power the device. Also, when the device is in wireless mode, it does not need to transmit the speech parameters of all spoken sounds wirelessly to the base and hence not use the limited bandwidth.

This quiet hours trigger may be used to indicate to the user that its listening is impaired and “don't speak to me just yet.” Such a condition may take place if the room has loud music or sound and that the device input circuitry is saturated and is unable to hear its name or a command. Under such a condition, the quiet hours indicator (such as an LED) may flicker, brighten, blink, etc.) to indicate that the unit is unable to hear its name—just like in a Quiet Hour mode. Such a configuration may also prevent false trigger due to strong acoustic coupling. In some device designs, there may be strong acoustic coupling between speakers and microphones which overwhelms and saturates the input microphone. Under such conditions, the device may indicate to the users that it is unable to hear any command and may turn on the Quiet Hour indicator.

### BRIEF DESCRIPTION OF THE DRAWINGS

The above described features and advantages of the present invention will be more fully appreciated with reference to the detailed description and appended figures in which:

FIG. 1 depicts a network diagram showing the distribution of base and client devices for use with the present invention.

FIG. 2 depicts a schematic diagram showing the preferred components located in the base and/or client devices of FIG. 1, including the quiet hours module of the present invention.

FIG. 3 depicts a flowchart showing the steps utilized by the quiet hours module when it is active.

### DETAILED DESCRIPTION OF THE INVENTION

The present invention discloses a system and method for controlling the behavior of a device in response to voice commands or other system events. By utilizing the system of the present invention, a user may select the time period(s), or the system may automatically select the time period based on certain conditions such as day of the week, system event, urgent message, etc., during-which the device is more or less responsive to voice commands. Furthermore, when the device is more or less responsive, any external trigger such as a message announcement, alarm, email alert, etc., the device takes into account its current “responsiveness” and behaves differently than when it is in a normal mode.

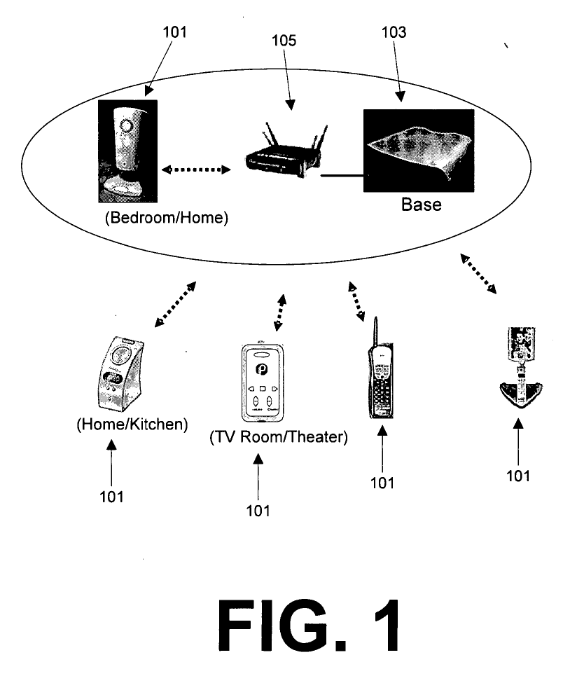

With reference to FIG. 1, depicted is a network diagram for use with the present invention. The system of the present invention can be implemented on any one of a plurality of client device 101 or base devices 103 which are dispersed throughout a home. For example, base device 103 may be located in a home office while different client devices 101 may be located in the bedroom, kitchen, television room, etc. All of the client devices are preferably in communication through a wireless network managed by wireless or wired server/router 105. The speech recognition can either be performed locally on each of the client devices 101 or base device 103, or it may all be performed at one or more central locations using a distributed processing architecture.

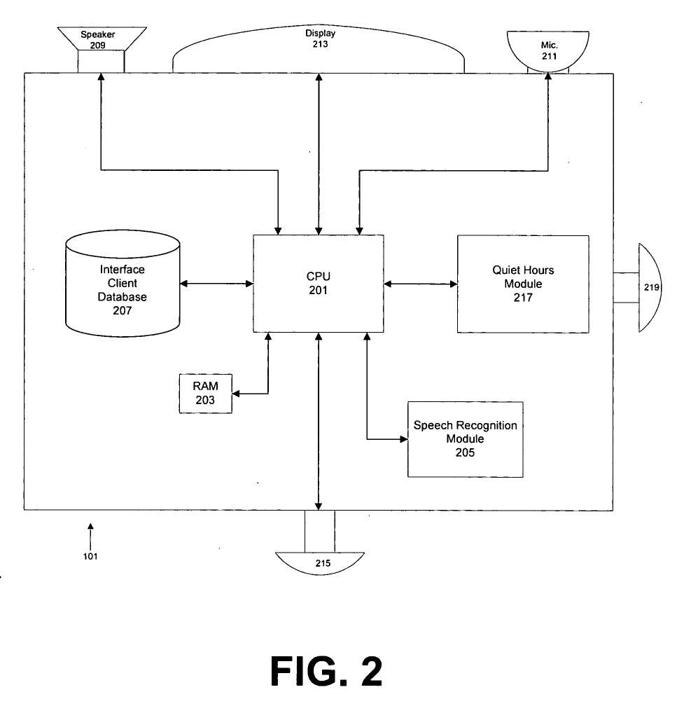

Referring next to FIG. 2, shown is a schematic diagram of the preferred components located in client devices 101. For clarity, the invention will be described with reference to client device 101, although it should be obvious to one skilled in the art that the system of the present invention could also be utilized in base devices 103.

As shown, the devices preferably contain central processing unit (“CPU”) 201, random access memory (“RAM”) 203, speech recognition module 205, interface client database 207, one or more external speakers 209, one or more microphones 211, visual display 213, attention button 215, quiet hours module 217, and quiet hours button 219. CPU 201 is responsible for controlling the interaction between the different components of client device 201. For example, CPU 201 is responsible for passing voice data from the microphone's 211 A/D and D/A to speech recognition module 205 for processing, controlling the information on the visual display 213, etc.

The computer “personalities” which interact with users are stored in the interface client database 207 connected to CPU 201. During normal operation, the client device 101 constantly monitors (listens) for an attention word—a spoken word or sound such as device name or some trigger sound. Each sound and utterance received by microphone 211 is digitized, appropriately processed by the front end (not shown) (end pointing, automatic gain control, background noise cancellation) and passed to CPU 201, which transmits it to the speech recognition module 205. As previously discussed, CPU 201 may reside locally on a client device 101 or the speech data may be transmitted to another CPU which may be dedicated for quiet hours processing and related tasks. If speech recognition module 205 recognizes an “attention word,” client device 101 becomes active and responsive to other voice commands. It should be obvious to one skilled in the art that CPU 201 may also perform the functions of the speech recognition module 205 if it has sufficient processing power.

After detection of an attention word, client device 101 accesses interface client database 207 and loads the correct interface client into RAM 203. An interface client is a lifelike personality which can be customized for each user of client device 101. Different applications installed on client device 101, such as an application for playing music, may utilizes customized interface clients to interact with the user. For example, an application which plays music might use an interface client which behaves like an upbeat disc jockey.

Once the interface client has been loaded into RAM 203, it is able to interact with the user through the speaker(s) 209 and microphone(s) 211 attached to the external housing of client device 101. The interface client may also utilize visual display 213 to interact with the user. For example, the interface client may appear as a lifelike character on visual display 213 which appears to speak the words heard through speaker 209. In the preferred embodiment, the interface client stays active for a predetermined amount of time, after which client device 101 again begins monitoring for an attention word.

Quiet hours module 217 is a programmable module which allows the user to set the time period(s) during which client device 101 will not respond to an attention word. If a user accidentally speaks an attention word or the system mistakes room noise or other speech for an attention word while quiet hours module 217 is active, the device will not respond. This feature is useful to prevent client device 101 from waking up at night and disturbing the user or if some users are constantly saying an ‘attention word’ to play with the system, etc.

Modes of Operation

There are many modes in which the quiet hours module 217 may operate. In the preferred embodiment, a user can program or select the different modes of operation by interacting with the device through spoken commands.

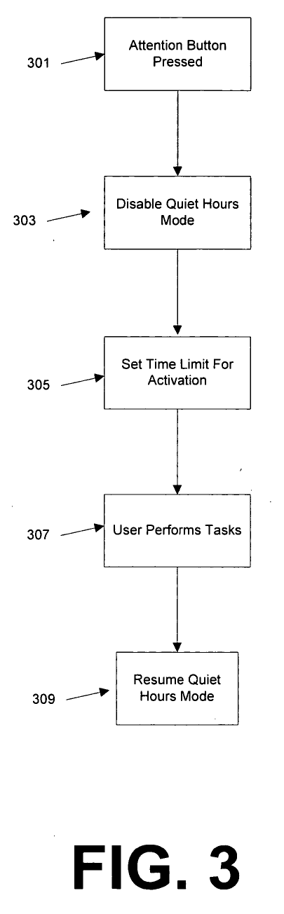

In a first and preferred mode of operation, the quiet hours module disables the speech recognition module while it is active. As is shown in FIG. 3, the only way for a user to interact with the interface client in this mode is for the user to press the attention word button in step 301. After the attention word button has been pressed, CPU 201 overrides the operation of the quiet hours module in step 303 and reactivates the speech recognition module for a predetermined period of time in step 305. During this time period, the user may interact with the interface client in step 307. After the time period has expired, the quiet hours module resumes its pre-programmed operation in step 309.

Other Methods of Setting Quiet Hours

In addition to pressing the Quiet Hour button, the quiet hours may be settable in other ways including
4) a user giving verbal command such as “stay quiet for 30 minutes” or “go into Quiet Mode”, etc.;
5) Using a web configuration utility to set the operation of the quiet hours module 217 for the present or for some future time span in as a single or a recurring event;
6) the client device application asking the user if the users would like it go in Quiet mode (for example when the system keeps waking up and there are no commands after that).

In a second mode of operation, the quiet hours module may only be deactivated in response to a pre-programmed event. For example, if the user had programmed the device to activate an alarm during a period when the quiet hours module was scheduled to be active, CPU 201 would override the operation of the quiet hours module and sound the alarm at the scheduled time. After the system event has taken place, the quiet hours module 217 would then reassume its pre-programmed operation.

Upon setting the Quiet mode, the device may give a verbal acknowledgement and/or visual (via LED or graphics message on display 213) and/or web application trigger if the device status is visible to the web.

For some client devices 101, quiet hours may not be an option or settable and when quiet hours button 219 is pressed, the system will announce to the user that “Quiet hours is disabled . . . ” and that the Quiet Hour indicator would not be turned on. This feature would be helpful if a parent did not wish to activate quiet hours module 217 for their kids room and wanted to constantly monitor for any sound activity. Another variation of this mode may be that when quiet hours module 217 is active, the device will not respond to and the device will not understand user voice activation. However, the system is still able to respond to an incoming telephone call, event trigger response using other buttons or screens.

Another variation of this mode may be that when the quiet hours module 217 is active, the device will not respond to and the device will not understand user voice activation. However, the system is still able to respond to a telephone ring, event trigger, using other buttons or screens. There may be some event triggers that are of high or critical level and will require users' attention. Other events, such as system maintenance, RSS feeds of non-critical events, a blog update or posting, an incoming ad message, voice mail message which is not marked urgent or the system does not identify as known urgent message, may be ignored and stored for release after the quiet hours module 217 is deactivated. To avoid inundating the user with messages, the device may hold off sharing these individual messages and offer the user a summary of the different trigger events.

For a device with a dedicated—visual display (such as display 213), trigger events, message counts, and type of message, may be displayed. In this mode, during quiet hours, the screen may not brighten depending on the setting and time of day, etc. For devices which don't have a dedicated display and use screens from other appliances or device functionality (including Quiet Hours) is partially or fully embedded in these appliances such as such as a TV, Home Theater, Game Player, or other Display screen, these screens may not turn on or fully brighten during quiet hours mode to minimize the disturbance. Some of these appliances have their own audio that can be misunderstood for an “attention word,” a “command trigger,” or a “conversational trigger.” For these appliances, quiet hours may be activated when the user is using the appliance to some capacity or capability. For example if the TV appliance is playing a show, Quiet Hours may be enabled automatically to avoid false trigger.

Quiet hours module 217 may utilize different threshold levels. For some devices, it may be on or off, but in other devices where great deal of background noise exists or a TV is playing in the background, the strong “attention word” or “command” needs to be heard for the device to respond. Depending on the threshold level, the quiet hours indicator's brightness may vary (far brighter if it is completely shut off or less bright if it requires a strong recognition of “attention word/command.”

In an alternate embodiment of the present invention, quiet hours module 217 settings may be unique for each interface client. In this embodiment, the quiet hours module settings for the active interface client will be utilized unless a global setting has been set for all interface clients.

The operation of quiet hours module 217 may also be interrupted when a validated urgent message is detected by the device. In response to the message, the device may notify the user of the message via blinking LEDs or a text display of the message. The quiet hours LED or indicator may also blink alerting a user. The device will then deactivate the quiet hours module and listen for an attention word and/or other command spoken by a user.

In some configurations, a user may be able to deactivate the quiet hours module by saying a special word or phrase several times such as “‘personica’ wake up; ‘personica—wake up.” This feature would be especially useful for handicapped people who are unable to access or locate the device (such as a blind person).

Another advantage of the “quiet mode” which occurs when the quiet hours module 217 is active is that the processing burden on CPU 201 is significantly reduced. During this mode, the CPU can perform self diagnostics, tuning, monitor background noise, play multi-channel music in other rooms on other devices, cache data for the user in anticipation of commonly requested data, download new application(s), and/or conserve power if batteries are being used to power the device. Also, when client device 101 is in wireless mode, it does not need to transmit the speech parameters of all spoken sounds wirelessly to the base and hence not use the limited bandwidth.

This quiet hours trigger may be used to indicate to the user that its listening is impaired and “don't speak to me just yet.” Such a condition may take place if the room has loud music or sound and that the device input circuitry is saturated and is unable to hear its name or a command. Under such a condition, the quiet hours indicator (such as an LED may flicker, brighten, blink, etc.) to indicate that the unit is unable to hear its name—just like in a quiet hours mode. Such a configuration may also prevent false trigger due to strong acoustic coupling. In some device designs, there may be strong acoustic coupling between speakers and microphones which overwhelms and saturates the input microphone. Under such conditions, the device may indicate to the users that it is unable to hear any command and may by itself turn on, blink, dim the quiet hours indicator.

While specific embodiments of the present invention have been illustrated and described, it will be understood by those having ordinary skill in the art that changes may be made to those embodiments without departing from the spirit and scope of the invention.

I claim:

1. A method for controlling the activation and behavior of a device capable of user interface via multi-modal speech recognition comprising the steps of:
enabling a quiet mode setting on said device which prevents said device from responding to vocal commands and playing back vocal messages/information;
deactivating said quiet mode setting for a predetermined period of time in response to a specific event; and
resuming the programmed operation of said quiet mode setting when said predetermined period of time has expired.

2. A method according to claim 1, wherein said specific event is when a user pushes an attention button located on said device.

3. A method according to claim 1, wherein said specific event is a specific sequence of vocal commands.

4. A method according to claim 1, wherein said specific event is at least one consisting from the group of scheduled maintenance, a RSS feed of non-critical events, a blog update, a blog posting, an incoming advertisement message, alarm, multiple commands, a voice mail, an email message, and a telephone call.
